(19) United States
(12) Patent Application Publication
(10) Pub. No.: US 2009/0300128 A1
(43) Pub. Date: Dec. 3, 2009

(54) E-MAIL AUTHENTICATION PROTOCOL OR MAP

(76) Inventors: Steven E. Trupp, Brightwsters, NY (US); Elizabeth Powers Trupp, Brightwaters, NY (US); Peter Theobald, Huntington, NY (US); Robert Bente, Oakdale, NY (US)

Correspondence Address: BUCHANAN, INGERSOLL & ROONEY PC, POST OFFICE BOX 1404, ALEXANDRIA, VA, 22313-1404, US

(21) Appl. No.: 12/537,786

(22) Filed: Aug. 7, 2009

Related U.S. Application Data
(63) Continuation of application No. 11/089,558, filed on May 21, 2003, now abandoned.

(51) Int. Cl. G06F 15/16; G06F 21/00

(52) U.S. Cl. 709/206; 726/3

(57) ABSTRACT

Disclosed is a system and method to eliminate undesirable electronic mail (email) communications sent via the Internet. The invention eliminates undesirable email prior to delivery of the email message, thereby minimizing the negative impact of undesirable email while adhering to established Internet protocols and processes regarding email Delivery Status Notifications. The system does not require evaluation or scrutiny of the actual contents of an email message, thereby avoiding false positives (blocking of desirable email) and the real or perceived invasion of privacy issues associated with scanning personal and business email communications. The system can execute unilaterally and can be universally adapted as it evaluates the TCP/IP and SMTP protocol and transmission data attendant with every email message. The system operates independently, is not dependant on any third party lists or definitions of spam and does not require any pre or post delivery coordination between senders or recipients.

### CROSS-REFERENCE TO RELATED APPLICATIONS

This application is a continuation of U.S. application Ser. No. 11/089,558 filed on May 21, 2003, now U.S. Published Application No. US-2007/0005970-A1 which claims the benefit under USC 119(e) of U.S. Provisional Application No. 60/472,799 filed on May 21, 2003, the entire contents of which are incorporated herein by reference.

### DISCLOSURE

1) Field of the Disclosure

The disclosure is directed to the detection and controlled disposition of ‘spam’ or Unsolicited Commercial Email (“UCE”) sent across electronic networks such as the Internet and which utilize standard Internet mail transmission technology.

2) The Present Disclosure

The present disclosure is directed to an automated system or MAP (Mail Authentication Protocol) that can verify and authenticate certain key features of Internet email messages and does so without actually taking receipt of the message that is being assessed. This provides a number of advantages, not the least of which is that the user of the MAP system does not have to take possession of a spam message in order to perform an evaluation as to whether the message is spam. Thus, an email user seeking to avoid spam need not receive and then dispose of the spam email, they can avoid receipt entirely.

A second benefit is to network services operators, such as those supporting mail relay systems, in that much spam cannot be properly delivered or returned to the sender, and if a network operator takes receipt of an email message, that operator is obligated under existing informal Internet mail processing standards to continue to try to deliver or return such message, often for up to five (5) days, even though the message lacks critical information needed to perform this function.

Finally, the MAP system respects the business and economic realities by allowing the sending of email to recipients with whom the sender has no prior relationship (e.g. electronic direct marketing) by only requiring such sender to properly address their email and ensure that a return email address or return path is available for the recipient to use to contact the sender. The MAP system therefore speaks to the needs to senders, processors and recipients of Internet email.

Embodiments of the system can also improve upon existing anti-spam technology because it does not filter or restrict email messages based on content of the message, email address, originating domain or other predetermined criterion. Many existing spam detection systems rely upon restricting messages based upon detection of specific words or characters in the body or subject of the email message, or by keeping or otherwise checking lists of known spam senders or third party systems believed to be illegally used by or vulnerable to unauthorized use by spam senders. These methods are ineffective because the professional spam senders will deliberately make minor changes to message content or will rotate and change sending email addresses to defeat content checking or list based filtering systems. A prime objective of the embodiments of the MAP system is establishing a mail authentication system that could avoid these problems and add the additional significant benefit of not requiring significant ongoing human involvement once the system is installed and configured.

The present MAP system overcomes limitations of existing spam detection/suppression systems by operating in some ways as an Internet “mail policeman” essentially forcing the sender of an email message to include in any message certain basic and accurate data about the sender and the transmission route. It does not, by design, assess the body or contents of the message. The MAP system requires that the sender of an email message be able to receive email to the same email address as was used when the message was sent. The data required to be present includes, but is not limited to, the sender's email address. A common problem of spam is that the senders intentionally use fake or forged “From” addresses that don't allow the recipient to reply to the sender. Having a valid “From” or reply address is key to allowing a recipient to either do business with an email sender or to complain to the sender if they feel the message is improper, or if the recipient wishes to be removed from the sender list to avoid receiving further correspondence from that sender. Most importantly, the MAP system is sender neutral. That is, so long as a sender includes a valid email “from” address and includes other reliable information (including but not limited to the maintaining of a valid email address on the email server sending the email) the email will be processed by MAP. MAP essentially forces email senders to be ethical in sending email and to include such basic and reliable information as will allow a recipient to contact and locate the email sender. In many ways, MAP is both sender neutral and receiver neutral by allowing the senders of bulk marketing email to do so, and allowing potential customers to receive such commercial communications, but the system requires all such messages to be traceable and able to be responded to. The Exemplary embodiments of the present system operate by using “sensing” technology that allows a MAP enabled mail system to examine certain attributes of a message without actually receiving the message. The sensing is achieved by anticipating the existing functionality of Internet email transmission systems whereby portions of the email transmission data are captured for evaluation by MAP, without MAP causing actual receipt of the email. The MAP system will then determine whether the message should be accepted or rejected.

The invention operates in conjunction with the Internet mail transmission system known as Simple Mail Transport Protocol (SMTP). The MAP system can be installed at any location on the internet where the MAP system invokes certain routines and operations in conjunction with an/the SMTP processor. The MAP system operates by subjecting every email sent to be received by an SMTP process to a series of tests and authentication protocols. It is primarily directed but not limited to detecting and barring the receipt, at a protected system, of all unauthenticated email messages. In operation, the system verifies the source of, and/or the third party responsible for sending, any email message before accepting receipt of the message. In application, this unique and novel anti-spam system and/or service is called MAP (“Mail Authentication Protocol”). Exemplary embodiments of the system is primarily directed to detecting and controlling the disposition of an unauthenticated email message. Exemplary embodiments of the system is further directed to identifying when a fraudulent or forged email sender address has been used (or is attempted to be used) and where a server forwarding a message, or its designated alternate server, cannot verify the authenticity of a given email address claimed by the sender as their “from” or reply address.

The MAP system is an integrated system, ideally installed either at a network location as an intermediary mail relay point between the sender and a designated recipient, or placed at the recipient locales, such as a corporate email server or an ISP's inbound email processing locations. The MAP system, in certain embodiments, comprises a series of methods and a series of software and system processes that collectively serve to detect and allow controlled processing of a message. The MAP system works in conjunction with any system running the Simple Mail Transfer Protocol (SMTP or its derivatives, such as ESMTP) that receives email messages sent across electronic networks running transmission control protocol/internet protocol (TCP/IP).

The MAP system overcomes an array of limitations presented by present anti-spam email solutions including:

1. It does not depend on content filtering where keywords or pattern analysis is used in an attempt to detect spam. These systems are overcome and can be defeated by spammers by knowing the keywords being sought or by understanding the pattern algorithm being used for content filtering, and varying the message payload to defeat the filter.

2. It does not depend upon content analysis, and so avoids the personal privacy concerns and security issues attendant on such analysis.

3. It does not require any coordination between a sender and a recipient to ensure mail can be sent and received. Some systems rely on a challenge and response technique, or a pre-approved list of senders approach, each of which require some level of coordination or additional communications between a sender and a recipient in order to ensure mail may be sent and/or received. Rather, any validly configured message will pass MAP if the sender's identity (as described herein) can be fully authenticated.

4. It is entirely passive and once configured requires minimal administration and does not introduce any SPOF (Single Point of Failure) with respect to the delivery of email or delay the delivery of email messages. This enhances system reliability and ensures email is processed and delivered.

5. It may be used in conjunction with any existing anti-spam applications or systems to complement the operations of these systems.

The MAP system is neutral in application in that it processes all mail, provided the email is itself properly identified. MAP does not specifically target for rejection email because it is UCE (Unsolicited Commercial Email) or spam; rather MAP requires that sender of UCE must confirm the source of the UCE, and their accountability as the sender. The sender must also confirm that their UCE sending systems are available and responsive directly to the recipient of the UCE, for example when the recipient sends a “Remove from mailing list Request” and that request is sent via SMTP.

### DETAILED DESCRIPTION

MAP evaluates an email message by remotely discovering certain specifics of the email message header information also referred to as the “envelop.” This allows determination of whether adequate sender data and other information have been included, without taking possession of the subject email message. An email message essentially has two components—email header or envelope information and an email payload. “Payload” generally refers to the actual message that is being sent and includes any attachments or additional information or materials. Header or envelope information contains the essential routing data, formatted per the SMTP protocol, which provides the email message with its ultimate destination as well as the return path to the sender or the responsible party acting on behalf of the sender. All email transported across the Internet requires that at least two servers or computers executing the SMTP protocol, one server sends and one server receives, both or all or which servers are utilizing, dependant on, and have access to, DNS (Domain Name System) servers. DNS servers function as the routing directory for SMTP servers. All Internet email should properly include a sender address and a recipient address, which addresses include a domain name (The domain name is the portion of an email address after the @ sign).

In operation, SMTP servers read the domain name portion of an email address and look up the route over which send an email addressed to that domain on a DNS server. Every unique domain name has, as part of its domain name registration, a NS (Name Server). This NS is the location of the domain's DNS records, where an SMTP server, directly or indirectly, will determine where to send an Internet addressed email to that domain.

The SMTP protocol operates under the premise that mail delivery must be attempted. The systems will either deliver an Internet addressed email or it will confirm back to the sender that it was unable to deliver an Internet addressed email. To do this an SMTP server sending an email must confirm that the domain to which the email is addressed must exist (i.e., that there are NS servers registered for this domain, and that there is a DNS record on the NS server indicating where to send email addressed to this domain). Conversely, an SMTP server receiving an email from any SMTP sending server determines the sender's address, specifically the domain portion of this address and checks that this domain exists, (i.e., checks that there are NS servers registered for this domain). The check by the receiving SMTP server that the domain exists is performed to support the underlying SMTP protocol foundation that if the Internet email message cannot be delivered to the recipient, then SMTP will be able to return a confirmation to the sender indicating a failed delivery event and/or the conditions associated with an undeliverable message. This check performed by a SMTP receiving server (that the domain indicated as part of a sender's address must exist) is perceived as, and in fact functions as, a limited security check, thereby preventing the use of bogus or non-existent domain names as part of an email address. However this check is limited to determining only that the domain exists (i.e., to determining the existence of registered NS servers for the domain).

As a receiving SMTP server checks only that the domain portion of the senders address must exist, there is no further examination by SMTP as to whether an email message can actually be sent to or returned to the sender. This feature of SMTP is routinely taken advantage of by senders of UCE who wish to hide or obscure the source of the UCE. The MAP protocol is applied to the Internet email systems to defeat this type of abuse because the MAP requires that an accountable source of the UCE must be verified before MAP will signal SMTP to accept a message from the sender.

When MAP is deployed on an SMTP receiving server it can fully authenticate the return address of a sender to determine if the sender of an email is attempting to forge or falsify, through omission or otherwise, that there is a verifiable return address for the sender. More specifically, MAP requires that there is a party that will/can be accountable, as, or on behalf of, the sender of an Internet email before that email is delivered.

Included in the critical header or envelope information of the email is data telling the internet SMTP mail system who sent the message, from what server the message was sent, and to whom it should be directed for receipt (other non-relevant data is also included in the header). SMTP email (and most internet traffic) essentially is received and forwarded by a series of servers and routers. The header information guides an email message through these server and router ‘gates.’ Today, a forged or bogus email address (often used by spammers) will be forwarded across the internet and the routers and servers processing such a message will not verify adequately or completely certain characteristics of the message to determine if it has valid email header data. MAP introduces what could be called an “intelligent gate” in the sense that a server running MAP becomes a “smart” gate imposing certain rules on mail sent through it. MAP does this by using sophisticated data sensing technology which allows the MAP enabled server to capture essential data associated with the email header/envelope data concerning the email which is being attempted to be sent to the server running MAP. Most significantly, however, MAP acquires this data without formally accepting the message under SMTP rules. This allows for the examination and confirmation of the email address of the email sender, and also allows for the determination of the status of the sender's email account at the server that is claimed to be associated with such email account, prior to acceptance by the SMTP receiving server. The MAP system has been designed to detect and confirm when false or forged elements are included in a sender's email address that suggest the sender is issuing spam or UCE. The MAP system then prevents receipt of the unauthenticated message at the receiving or destination server (or at any server or MAP enabled monitoring point in the email transmission chain). The MAP system, in certain embodiments, uses multiple verification routines. Only those email messages which pass all such tests, are formally received by the MAP enabled mail server. Notably, the MAP system can preserve an abstract of the header information of all messages which are processed, found to lack the required verification elements, and denied receipt at the MAP enabled server.

The MAP system operates by monitoring incoming mail in real time, and before the incoming mail message is actually received, it determines or tests that incoming message as if that message was to be sent back to the sender as outgoing mail. In all cases, MAP determines and records the network address and host name of the mail server attempting to send email, (as established during the SMTP connection function), the stated fully qualified email address (as established as the SMTP MAIL FROM function), the intended recipient's fully qualified email address (as established as the SMTP RCPT TO: function), and the “SUBJECT” of the email, if any, (as established during the initial transmission of the SMTP DATA:).

The MAP system accomplishes the examination and recording of this information, which is the first and mandatory step in the MAP process, entirely passively by essentially eavesdropping on the established SMTP session. Because every SMTP session is a result of a request by a sending server attempting to send an email, there is always a unique session ID created on the receiving SMTP server, for each attempt to send an email. This occurs regardless of whether a receiving mail server is a MAP equipped/configured system. All Internet email is transmitted via the SMTP (Simple Mail Transfer Protocol) standard, which standard requires that both the sending and receiving mail servers include a minimum/mandatory number of commands and responses. As a result, any Internet mail server is a candidate, without modification of the SMTP protocol/process, for a MAP implementation.

The passive and background operation of MAP, and the importance of this aspect of the MAP system is further amplified in that MAP does not represent, for any MAP equipped mail server, any new or additional SPOF (Single Point of Failure) that could affect the delivery of an email, or introduce any noticeable delay in the delivery of an email. The MAP system has been designed to passively inspect only the SMTP connection and addressing elements of and inbound email message for use during the MAP authentication process.

The MAP system does not inspect, evaluate, record, or “see” any aspect or elements of the actual email correspondence. This is in contrast to many other email anti-spam solutions that involve interrogation of the message contents. Such an interrogation of email content raises attendant privacy implications. The MAP system does record the Subject: of an email message but only for the purpose of supplementing/complementing the MAP system reports comprising “Email traffic statistics and Spam reports” but does not utilize the content, actual data or lack thereof, of/in an email Subject: as part of the MAP authentication process. The MAP system can use multiple verification routines, and only those email messages which pass MAP verification are allowed (i.e., accepted for subsequent transport) by the SMTP process. Messages that fail a MAP authentication process are treated as “Rejected.” Messages that MAP cannot conclusively verify are treated as “Deferred.” MAP thus operates in a way that fully implements and is fully compliant with existing SMTP commands and protocol.

The MAP system is an integrated system comprising a set of methods and a series of processes that collectively serve to detect, and suppress or deny receipt (i.e. ensure non-transmission), of any email correspondence that fails the MAP verification procedures. This suppression of any correspondence that fails authentication is executed by refusing to accept or complete the inbound email transaction initiated by the sending server. The system does not need to queue or otherwise store for later inspection, (e.g., via automated pattern matching systems or human inspection) or for a final determination, any email message that fails the MAP authentication. This is especially important to Internet service providers and network operators, who would be ideal users of MAP. These entities do not want to take possession of spam with the attendant obligation and burden of either attempting to deliver, or returning to the sender, these messages that by the design of the spam sender have false addresses and are not meant to be able to be returned.

A significant feature of the MAP system is that it determines the status of a given transmission in real-time (where real-time means that the verification is done substantially concurrently with initiation of the request to send a message by the sending server). The MAP system may be deployed by installing any intermediary point between a sender of an email message and an intended recipient. In the case of internet email verification, this allows the MAP system to be deployed and installed at literally any location accessible on the Internet. The only requirement is that the monitoring point must allow for email traffic to be regularly and routinely routed to the MAP equipped SMTP server, processed by the MAP system and then relayed on to the ultimate intended recipient. Essentially, MAP may be run almost anywhere that an SMTP enabled server is present.

### Systems Environment.

The invention is presently deployed and has been tested as a part of a suite of services offered by a network services provider that processes email on behalf of third party clients. The invention was previously believed by experts in the industry to be impossible for at least three main reasons:

1. Delay in transport of email. It was believed that any effective anti-spam solution using an intermediary or relative processing of email would necessarily entail introducing an unacceptable delay or latency to messages that the MAP system processed and authenticated.

2. Burden on computer processors. It was believed that the increase in demand on the processing power of the computer servers (which run SMTP) would be so great as to make non-economic or cost-prohibitive any effective intermediary and real-time processing of email to detect and remove spam.

3. Increase in needed network transport resources or bandwidth constraints. It was believed that any reliable spam or fraudulent network communication detection system would necessarily entail a significant (order or magnitude or greater) increase in the required data transport capacity or bandwidth of a given network. This is because it was believed that material amounts of data would need to be routed between an intermediary detection system situated at some intermediary monitoring point and those network points at which messages originate. It was believed that such data transport volume would again make non-economic or prohibitively costly the operation of the intermediary detection system.

The MAP system addresses these shortcomings and achieves near 100% detection and suppression of email transmissions that cannot be authenticated by the MAP system. The MAP system does this: 1) without any material delay or latency in the transmission of a given message, 2) with only a minimal increase in the computer server processing load (e.g., an increase of less than 10%), and 3) without materially increasing the bandwidth or data transport requirements of the operation of the email system because the MAP system monitors and processes only minimal amounts of email related data.

Presently, the MAP system is offered to the public under a fee based service agreement with ICS Network Systems, Inc. offered as a part of the Mail Sentry brand email services. The Mail Sentry service is configured as a mail relay service and as such represents an ideal intermediary location to process and authenticate messages because a mail relay service is neither the initial source nor a final destination of email traffic. Mail Sentry deploys the MAP invention as this ‘middle-man’ location to intercept, process and authenticate every message before relay to a Customer. The MAP system is designed to work equally well in an email systems/services implementations where the mail servers are either the final destination or the initial source of an email correspondence.

Other service elements of the Mail Sentry systems are Gateway virus scanning Services and anti-mail relay security. Customers utilizing the Mail Sentry service publish, as part of their establishment of internet domain DNS (Domain Naming Service) records, Mail Exchanger (MX) records that route email for their domain exclusively through the designated Mail Sentry systems for subsequent relay to Customer's premise based email server or to the Mail Sentry Network mailboxes. In short, these customers out-source to Mail Sentry the functions of virus scanning and email integrity checking as per the MAP system for all of their corporate email. With current estimates indicating that up to 60% of email to corporate mailboxes being spam, businesses and network operators themselves are keenly interested in reducing the amount of spam that they receive or that their networks carry.

The MAP system was conceived and developed to significantly reduce the number of un-solicited email correspondence to both Mail Sentry Gateway and Network Mail box subscribers. The impetus for the development of the MAP system was manifold, but two were primary:

1) Customers were burdened and concerned by the amount of spam they received, especially the type of spam considered offensive and/or offering illegal products, and which in practice nearly always has a false or forged sender address.

2) The network or email service provider, operating as a mail relay provider, was paying for bandwidth to transport spam traffic (which could never be associated with a valid recipients email address). This spam traffic burdened the network operator with the high overhead characteristic of trying to return bounce messages or notifications regarding undeliverable email.

The MAP system includes, but is not limited to, an on-line verification process of any sender's fully qualified email address who wishes/intends to correspond with anyone whose traffic is processed by a MAP equipped system. This is very important to those who legitimately use email for mass communication. Sending email through a MAP system requires that a sender of an electronic message properly identify their actual email address and ensure that such email address is properly configured and recognized by their email servers. This authentication function ensures that if a party wants to send email to someone that they do not have a pre-existing relationship with, they can do so provided they properly identify themselves as well as the server sending the email. This allows for a recipient to reach back and contact the sender. A prime problem with spam today is that a recipient of an unsolicited message is often unable to contact the party sending the message because the return address is false or the server at which such address is listed does not recognize or confirm such address. The MAP system thus allows the direct marketing industry and others to still communicate with members of the public and inform them of commercial opportunities, but does so in a way that compels the sender to include proper and accurate information on how to contact the sender. Accordingly, MAP balances the interests of commercial senders with email recipients and imposes certain basic levels of required proper identification if messages are to be allowed through the MAP system.

### Relationship of MAP and SMTP

The MAP system utilizes application software that is fully integrated with the industry standard SMTP (Simple Mail Transfer Protocol). As soon as an inbound SMTP connection to a MAP enabled server is established, the MAP protocol determines the relevant sender's address and connection data and immediately initiates/performs the following tasks.

1) The return mail route for the sender's email address is determined via an MX record lookup for the sender's domain. (If no MX record is published, a host (A) record for the domain is sought);

2) A telnet connection to port 25 on the host specified for the sender's MX record is immediately attempted, and if established;

3) A HELO or EHLO with the Mail Sentry host name is sent;

4) The sender's fully qualified email address and the intended fully qualified recipient address are then presented to the MX host for verification.

5) Using the intended recipient address as the mail from: and the sender's address as the rcpt to: the MAP system determines whether the MX host will validate the sender's address at or before a timeout value is exceeded for each of the MAP events;

6) The MAP system then evaluates the response(s) to the MAP query and instructs the local SMTP process, established during the inbound mail connection, how to proceed with respect to the pending SMTP transaction. Accept, Reject or Defer.

7) Depending on which determination the MAP system assigns to the inbound delivery request, MAP instructs the SMTP process as to which, if any, standard SMTP protocol Status response issues to the sending server. If MAP assigns an Accept designation, the SMTP process is signaled to continue/complete the inbound SMTP without further consideration of the MAP process, which is terminated. If the MAP authentication has failed, MAP instructs the SMTP process to issue a 500 Series error message to the sending server, stating “Message Not Accepted” If the MAP verification is not conclusive, MAP instructs SMTP to issue a 400 Series error message to the sending server, stating “Message Temporarily not accepted, Deferred Please try again later.”

The MAP verification process is initiated immediately upon receiving a connection from the sending server and logs the process ID (PID) of the established SMTP connection to support the inter-process dialogue between the local SMTP and MAP protocols. The SMTP process performing its own SMTP connection edits and checks, which are not interfered with by the MAP process. Until such time as the MAP process determines the ultimate status designated for the inbound correspondence, (Accept, Reject, Defer) the SMTP process is the master process and the MAP system monitors the SMTP session to acquire the data required to complete, or attempt to complete, authentication of the sender's address.

In certain respects, the MAP system is performing a similar process to that performed by the server that established the SMTP connection to send inbound mail, except the MAP process is limited to authenticating that the published return route for the sender's domain specifies a live host, and that the specified host supports the industry standard SMTP protocol and can authenticate the sender's address when submitted as the RCPT TO: address. If the MAP process proceeds to the last verification step, immediately upon receipt of the response to the RCPT TO: or if the MAP timeout variable for this sequence of the MAP process is exceeded, a QUIT command is issued by MAP and the connection established by the MAP system for verification purposes only, is closed.

The MAP system performs several preliminary checks immediately upon receiving the inbound SMTP connection and reserves the on-line verification of a sender's address as the last and final step of the MAP authentication process. For example, where there are many large ISPs/email service providers, such as AOL, Hotmail, MSN or Yahoo, and where outbound mail originating from these large ISP networks may only be expected to be processed by hosts (mail servers) known to be part of or resident on, these networks, the MAP system will identify whether the sender's address is being forged. A forged address is implied when, for example, a correspondent with a sender address @aol.com establishes an SMTP connection from a host other than an AOL host.

In one embodiment, the MAP system also utilizes a combination of static and/or dynamically updated “white” and “black” lists. Each day, any fully qualified sender address that is verified by the MAP system is dynamically added to a global “white” list. This white list is checked first each time MAP detects/monitors a new inbound SMTP connection, and if the sender's address matches an existing white list entry, MAP instructs the SMTP process to Accept the inbound correspondence.

Customer mail service administrators also maintain static “white” and “black” lists. White list entries are typically created/maintained proactively by a domain level administrator to permit expected email traffic sent by automated notification systems or “list servers” as most automated email notification systems and/or list servers will not respond to a MAP address verification request and, as a result, barring a white list entry, the mail will be deferred or rejected. The MAP system includes a series of software programs and MAP algorithms some of which operate in the form of “milters” which is the term used for SMTP mail filtering instructions.

What is claimed is:

1. A system for authenticating an electronic message from a sender prior to delivery to an intended recipient via a recipient electronic message processing system, comprising:
a monitoring portion, which examines an electronic message header or envelope for the presence of sender data;
a verification portion, which verifies the sender data;
a classification portion, which classifies the electronic message based upon the results obtained from the monitoring portion, the verification portion, or both; and
a notification and delivery portion, which notifies the recipient electronic message processing system of the results of the classification portion, and which delivers the electronic message to the recipient electronic message processing system if the classification portion indicates that the electronic message is authenticated.

2. The system of claim 1, wherein the sender data comprises one or more of a network address of a server attempting to send the electronic message, a host name of a server attempting to send the electronic message, a fully qualified email address of the sender, a fully qualified email address of the intended recipient, or a subject line of the electronic message.

3. The system of claim 1, further comprising a recording portion, which records some or all of the sender data.

4. The system of claim 1, wherein said sender data does not include message contents of the electronic message.

5. The system of claim 1, wherein said verification portion verifies the sender data by performing one or more of the following:
determining the return mail route for the email address in the sender data via a lookup for a mail exchanger (MX) host record of the sender domain; or
determining a host (A) record for the sender domain.

6. The system of claim 5, wherein said verification portion further performs the following:
attempting a telnet connection to the host specified for the MX host record of the sender domain;
presenting the fully qualified electronic message address of the sender and the fully qualified electronic message address of the recipient to the MX host;
determining whether the MX host will accept the fully qualified electronic message address of the sender as a recipient address and the fully qualified electronic message address of the recipient as a sender address prior to the exceeding of a timeout value; and
providing the response from the MX host to the classification portion.

7. The system of claim 1, wherein the classification portion performs the following:
receiving a response from the verification portion;
assigning a classification to the electronic message, based upon the response from the verification portion; and
providing this classification to the notification portion.

8. The system of claim 7, wherein the classification is selected from the group consisting of a classification indicating that the electronic message was authenticated, a classification indicating that the electronic message was not authenticated, and a classification indicating that the authentication of the electronic message has been deferred.

9. The system of claim 1, wherein the sender data is obtained from a Simple Mail Transfer Protocol (SMTP) process.

10. A method for authenticating an electronic message from a sender prior to delivery to an intended recipient via a recipient electronic message processing system, comprising:
examining an electronic message header or envelope for the presence of sender data;
verifying the sender data;
classifying the electronic message based upon the results obtained from the examining of the electronic header or envelope, the verifying of the sender data, or both; and
notifying a recipient electronic message processing system of the results of the classifying, and delivering the electronic message to the recipient electronic message processing system if the classifying indicates that the electronic message is authenticated.

11. The method of claim 10, wherein said verifying of the sender data comprises authenticating the return route for a domain of the sender of the electronic message, which is contained in the electronic message header or envelope, or authenticating the existence of a host supporting a standard electronic message processing protocol at the address of the sender specified in the electronic message header or envelope.

12. The method of claim 11, wherein said determining the return mail route for the email address in the sender data comprises carrying out a lookup for a mail exchanger (MX) host record of the sender domain; or determining a host (A) record for the sender domain.

13. The method of claim 12, wherein said determining the return mail route for the email address in the sender data comprises:
attempting a telnet connection to the host specified for the MX host record of the sender domain;
presenting the fully qualified electronic message address of the sender and the fully qualified electronic message address of the recipient to the MX host; and
determining whether the MX host will accept the fully qualified electronic message address of the sender as a recipient address and the fully qualified electronic message address of the recipient as a sender address prior to the exceeding of a timeout value.

14. The method of claim 13, wherein said classifying the electronic message based upon the results obtained from the examining of the electronic header or envelope, the verifying of the sender data, or both, comprises:
receiving the result of the determination by the MX host;
assigning a classification to the electronic message, based upon the response from the verification portion.

15. The method of claim 14, wherein the classification is selected from the group consisting of a classification indicating that the electronic message was authenticated, a classification indicating that the electronic message was not authenticated, and a classification indicating that the authentication of the electronic message has been deferred.

16. The method of claim 10, further comprising:
comparing (a) the mail server indicated by the header or envelope of the electronic message as having processed the electronic message with (b) host servers known to be part of the network indicated by the sender's domain;
classifying the electronic message as not authenticated when mail server (a) does not correspond with any host servers (b).

17. The method of claim 10, further comprising:
recording the results of the verifying of the sender data; and
comparing a fully qualified sender address of the electronic message as indicated in the header or envelope of the electronic message with a static or dynamic list of addresses that have been previously classified as authenticated or not authenticated.

18. The method of claim 10, wherein the sender data is obtained from a Simple Mail Transfer Protocol (SMTP) process.

19. The method of claim 17, wherein the list of addresses comprises a list of fully qualified sender addresses that have been previously verified.
